(19) United States
(12) Patent Application Publication
(10) Pub. No.: US 2026/0058172 A1
(43) Pub. Date: Feb. 26, 2026

(54) HUMIDIFIER

(71) Applicant: MAHLE International GmbH, Stuttgart (DE)

(72) Inventors: Felix Kleinheinz, Blaufelden (DE); Sven Alexander Kaiser, Waiblingen (DE); Marcel Holzner, Aglasterhausen (DE); Markus Auer, Stuttgart (DE)

(21) Appl. No.: 19/304,590

(22) Filed: Aug. 19, 2025

(30) Foreign Application Priority Data
Aug. 20, 2024 (DE) 102024123739.2

(51) Int. Cl. H01M 8/04119

(52) U.S. Cl. CPC H01M 8/04149; H01M 8/04141

(57) ABSTRACT

A humidifier for humidifying a dry supply air stream via a humid exhaust air stream may include a housing, a membrane block with a plurality of membranes, and at least one baffle. The housing may include a supply air inlet, a supply air outlet, an exhaust air inlet, and/or an exhaust air outlet. The membranes may be impermeable to air and permeable to water vapor. The membranes may form a supply air path through which the supply air stream is flowable and an exhaust air path through which the exhaust air stream is flowable. The baffle may be arranged in the housing such that an air stream formed by the supply air stream and/or the exhaust air stream contacts the baffle. The baffle may be structured and arranged to provide homogenization of streaming through the membrane block in the supply air path and/or in the exhaust air path.

### CROSS-REFERENCE TO RELATED APPLICATION

This application claims priority to German Patent Application No. DE 102024123739.2, filed on Aug. 20, 2024, the content of which is hereby incorporated by reference in its entirety.

### TECHNICAL FIELD

The invention relates to an air humidifier for humidifying a relatively dry supply air stream by means of a relatively humid exhaust air stream in accordance with the generic claim 1.

### BACKGROUND

DE 10 2020 212 596 A1 discloses a generic humidifier comprising a housing and a membrane block arranged in the housing. The housing has four connections that form a supply air inlet for supplying the supply air stream, a supply air outlet for discharging the supply air stream, an exhaust air inlet for supplying the exhaust air stream, and an exhaust air outlet for discharging the exhaust air stream. The membrane block has several membranes that are configured to be impermeable to air and permeable to water vapor and which form in the membrane block a supply air path through which the supply air stream can pass and an exhaust air path through which the exhaust air stream can pass. In the membrane block, the supply air path and the exhaust air path are separated from each other by the membranes, so that supply air remains in the supply air stream and exhaust air remains in the exhaust air stream, while moisture in the form of water vapor passes through the membranes from the exhaust air to the supply air. As disclosed in DE 10 2020 212 596 A1, the membranes can be designed as flat membranes and arranged in a stack in the membrane block. Alternatively, the membranes can also be designed as hollow fiber membranes, similar to DE 10 2015 224 202 A1, and arranged in bundles in the membrane block.

Such humidifiers can be used in particular in a fuel cell system, wherein the relatively dry supply air stream is formed by fresh air that is supplied to a cathode side of a fuel cell stack, while the relatively humid exhaust air stream is formed by exhaust air from a cathode side of the fuel cell stack.

In order to achieve the lowest possible stream resistance, the membrane block is relatively large, so that one side of the membrane block facing one of the connections has a significantly larger area than a cross-section of the connection facing this side of the membrane block, through which a stream can pass. This applies to a supply air upstream side of the membrane block whose surface area is larger than the cross-sectional area of the supply air inlet, through which a stream can pass. The same applies to a supply air downstream side of the membrane block whose area is larger than the cross-sectional area of the air outlet, through which a stream can pass. This also applies to an exhaust air upstream side of the membrane block whose surface area is larger than a cross-sectional area of the exhaust air inlet, through which a stream can pass. This relationship also applies to an exhaust air downstream side of the membrane block whose surface area is significantly larger than a cross-sectional area of the exhaust air outlet, through which a stream can pass. Due to the alignment and positioning of the connections on the housing, only a partial region of the membrane block is located in a drain region of the supply air inlet or exhaust air inlet and in the intake region of the supply air outlet or exhaust air outlet. This inevitably results in uneven streaming through the membrane block in the supply air path and in the exhaust air path. As a result, the humidification capacity of the air humidifier or the water transfer rate of the air humidifier is not optimally utilized. In particular, regions of the membrane block that are relatively far away from the respective connection are only poorly penetrated by the supply air stream or exhaust air stream.

### SUMMARY

The present invention addresses the problem of providing an improved embodiment for humidifiers as described above, which is characterized in particular by increased humidification performance or water transfer rate.

This problem is solved according to the invention by the subject matter of the independent claim(s). Advantageous embodiments are the subject matter of the dependent claim(s).

The invention is based on the general idea of arranging at least one baffle in the housing upstream or downstream of the membrane block in the supply air stream or in the exhaust air stream in order to homogenize streaming through the membrane block with the supply air stream or with the exhaust air stream. The homogenization of streaming through the membrane block is achieved on the one hand by positioning the baffle on the upstream side or downstream side of the membrane block and on the other hand by configuring the baffle in such a way that it has a homogenizing effect. With the aid of the baffle, for example, a section of the membrane block facing directly toward a connection can be provided with increased stream resistance so that an air stream formed by the supply air stream or the exhaust air stream is forced to divert and thus reaches other regions of the membrane block. This deflection or diversion of the air stream leads to homogenization of streaming through the membrane block.

In this context, “configuration” corresponds to “design” and/or “setup,” so that the phrase “configured so that” is synonymous with the phrase “designed so that” and/or “set up so that”.

Specifically, the invention proposes that the humidifier has at least one baffle arranged in the housing outside the membrane block in such a way that the baffle can be impelled by an air stream formed by the supply air stream or the exhaust air stream, wherein the baffle is arranged and/or configured in particular such that it causes homogenization of streaming through the membrane block in the supply air path or in the exhaust air path.

According to an advantageous embodiment, the respective baffle in the housing can be arranged between the membrane block and one of the connections such that the baffle faces this connection, in particular directly, i.e., directly or via the shortest route. This means that a projection of a cross-section—through which a stream can pass—of this connection parallel to the main air stream direction in this connection meets the baffle in the direction of the membrane block. In particular, the baffle may be arranged centrally in the housing with respect to this connection so that the projection in question meets the baffle centrally. This means that the baffle on the membrane block covers the region mainly exposed to the stream from the respective connection when it is arranged on the upstream side of the membrane block. When the baffle is arranged on the downstream side of the membrane block, it covers the region of the membrane block that leads directly to the respective connection.

According to an advantageous embodiment, the baffle can be arranged in the housing so that air stream can pass around it at the edges. In other words, the baffle allows the air stream to be deflected to a circumferential edge of the baffle, where it passes around the edge of the baffle, enabling regions of the membrane block that are relatively far away from the central region of the baffle to also be reached by the air stream.

An advantageous embodiment is one in which the baffle is configured so that air stream can pass through it. For this purpose, the baffle may be made of a porous material or have a honeycomb structure, a grid structure, or a mesh structure. The baffle can also be configured as a perforated plate. Due to the design of the baffle through which a stream can pass, the air stream can also pass to the region of the membrane block covered by the baffle.

According to an advantageous embodiment, the baffle can be configured such that the stream resistance in a central region of the baffle, through which a stream can pass, is greater than in an edge region of the baffle, through which a stream can pass. This measure forces the air stream to divert from the central region and stream more strongly towards the edge region. This supports the homogenization of streaming through the membrane block.

According to an advantageous embodiment, the baffle can have several passage openings through which the air stream can pass, wherein the passage openings that are formed in the central region have a smaller cross-section through which a stream can pass than the passage openings that are formed in the edge region. This ensures that the baffle has greater stream resistance in the central region than in the edge region.

In an alternative embodiment, the baffle may have several passage openings through which air stream can pass, extending from the central region to the edge region, wherein the passage openings in the central region have a smaller opening width through which a stream can pass than in the edge region. In other words, the passage openings diverge from the inside to the outside or converge from the outside to the inside. This measure also means that the baffle has greater stream resistance in the central region than in the edge region.

According to a particularly advantageous embodiment, a grid may be arranged on the upstream side or downstream side of the respective baffle, which may be configured to generate turbulence. The grid allows air to stream through it, but its grid structure creates turbulence in the air stream, which promotes homogenization of the air stream.

The grid can completely cover the baffle. The baffle may have a circumferential edge. The grid can be flush with this edge of the baffle or protrude beyond the edge of the baffle. In particular, the grid can extend to the housing and thereby cover a circumferential gap or annular gap between the baffle and the housing, in which a stream can pass around the baffle at the edges.

In another embodiment, however, it may be provided that a grid for generating turbulence is arranged or formed in each of the passage openings, wherein the grid completely fills the cross-sectional area of the respective passage opening. In this embodiment, the grid or grid structure is integrated into the baffle and is only effective in the region of the passage openings. One conceivable option is to use a grid as an insert in an injection mold for manufacturing the plastic baffle, so that the grid fills the cross-section of the passage openings in the passage opening and is otherwise embedded in the material of the baffle.

In another embodiment, such a baffle may be arranged in the supply air stream upstream or downstream of the membrane block in the housing. In addition or as an alternative, such a baffle can be arranged in the exhaust air stream upstream or downstream of the membrane block in the housing. The humidifier can thus have exactly one baffle in the supply air stream or exactly one baffle in the exhaust air stream. Alternatively, the humidifier can also have exactly two or more baffles, namely at least one baffle in the supply air stream and at least one baffle in the exhaust air stream. For the baffle in the supply air stream, it is preferable to arrange the baffle upstream of the membrane block, as an improved water transfer rate is expected there due to the resulting lower air pressure in the membrane block. For the baffle in the exhaust air stream, it is preferable to arrange the baffle downstream of the membrane block, as an improved water transfer rate is expected there due to the resulting higher air pressure in the membrane block.

In a particularly advantageous embodiment, such a baffle can be arranged in the exhaust air stream downstream of the membrane block in the housing and configured as a droplet separator. This gives the baffle an additional function, as it can be used specifically to separate liquid water carried in the exhaust air stream. The housing can also be equipped with a water collection volume. The baffle can then be conveniently configured to supply the separated droplets or water to the water collection volume. The water collection volume may have a drain valve so that water collected in the water collection volume can be drained from the water collection volume when a certain fill level is reached or periodically.

According to another advantageous embodiment, guide grooves may be provided on the upstream side of the baffle for guiding droplets separated on the baffle to the water collection volume. This improves the supply of water collected by the droplet separation at the baffle to the water collection volume.

According to another advantageous embodiment, guide ribs may be provided on the inside of the housing upstream of the membrane block for improved guidance of the supply air stream and/or the exhaust air stream to the membrane block and/or to the baffle, in particular to an edge region through which a stream can pass or an edge around which a stream can pass.

Alternatively or additionally, guide ribs may be provided on the inside of the housing downstream of the membrane block to improve the guidance of the supply air stream and/or the exhaust air stream away from the membrane block and/or from the baffle, in particular from an edge region through which a stream can pass or an edge around which a stream can pass.

The guide ribs improve the stream guidance within the humidifier housing. In particular, the guide ribs improve the inflow to the baffle, especially to the edge region through which a stream can pass or edge of the baffle around which a stream can pass, so that the homogenization of streaming through the membrane block in the supply air path or in the exhaust air path is additionally supported by the baffle.

The humidifier according to one of the preceding features can be used in particular for use in a vehicle.

Further important features and advantages of the invention are apparent from the subclaims, the drawings, and the accompanying description of the figures based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a setup, an apparatus, or an arrangement, which are designated separately, can form separate parts or components of this unit or be integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in:

FIG. 1 shows a greatly simplified, schematic cross-sectional diagram of an air humidifier in the region of a supply air path.

FIG. 2 shows a view as in FIG. 1, but in the region of an exhaust air path.

FIGS. 3 through 5 in each case, a highly simplified top view of a baffle in various embodiments.

### DETAILED DESCRIPTION

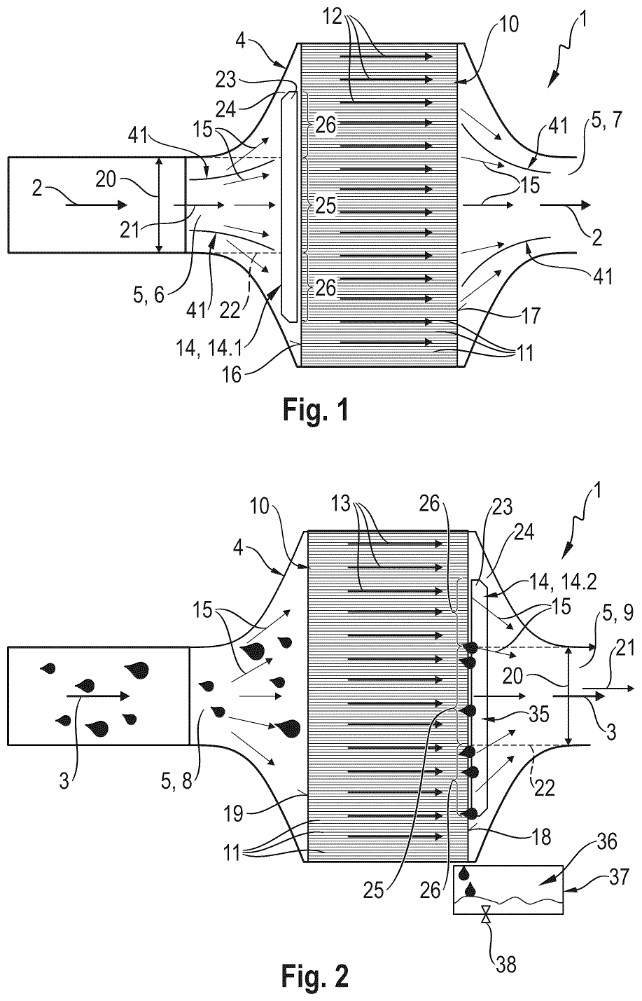

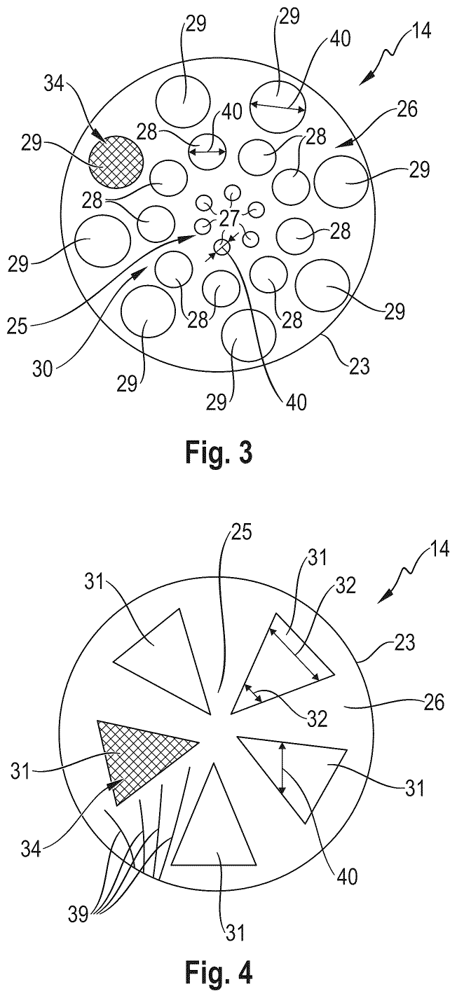

According to FIGS. 1 and 2, an air humidifier 1, which can be used in particular in a fuel cell system and which is designed to humidify a relatively dry supply air stream 2, indicated by arrows in FIG. 1, by means of a relatively humid exhaust air stream 3, indicated by arrows in FIG. 2, comprises a housing 4 having four connections 5. The four connections 5 form a supply air inlet 6, which can be seen in FIG. 1, for supplying the supply air stream 2, a supply air outlet 7, which can be seen in FIG. 1, for discharging the supply air stream 2, an exhaust air inlet 8, which can be seen in FIG. 2, for supplying the exhaust air stream 3, and an exhaust air outlet 9, which can be seen in FIG. 2, for discharging the exhaust air stream 3.

The humidifier 1 also has a membrane block 10 arranged in the housing 4, which has several membranes 11 that are configured to be essentially impermeable to air and essentially permeable to water vapor. The membranes 11 are arranged in the membrane block 10 such that they form a supply air path 12 in the membrane block 10, which is indicated by arrows in FIG. 1, through which the supply air stream 2 can pass, and an exhaust air path 13, which is indicated by arrows in FIG. 2, through which the exhaust air stream 3 can pass.

The humidifier 1 presented here also has at least one baffle 14, which is arranged in the housing 4 outside the membrane block 10. The baffle 14 is arranged in the housing 4 in such a way that the baffle 14 can be impelled by an air stream 15, which is indicated by arrows in FIGS. 1 and 2 and which is formed either by the supply air stream 2 or by the exhaust air stream 3. Furthermore, the respective baffle 14 is arranged and/or configured such that it causes homogenization of streaming through the membrane block 10 in the supply air path 12 or in the exhaust air path 13.

In FIG. 1, the baffle 14 is arranged in the supply air stream 2 and can also be referred to as supply air baffle 14.1 in the following. In the example shown in FIG. 1, the supply air baffle 14.1 is arranged on the upstream side of the membrane block 10, i.e., on an upstream side on the supply air side 16 or supply air upstream side 16 of the membrane block 10. Alternatively, the supply air baffle 14.1 can also be arranged on the downstream side on the supply air side 17 or supply air downstream side 17 of the membrane block 10. The arrangement of the supply air baffle 14.1 shown in FIG. 1 on the upstream side is preferred. In FIG. 2, the baffle 14 is arranged in the exhaust air stream 3 and can also be referred to as exhaust air baffle 14.2. In FIG. 2, the exhaust air baffle 14.2 is arranged on a downstream side on the exhaust air side 18 or exhaust air downstream side 18 of the membrane block 10. Alternatively, an embodiment is also possible in which the exhaust air baffle 14.2 is arranged on an upstream side on the exhaust air side 19 or exhaust air upstream side 19 of the membrane block 10. However, the arrangement of the exhaust air baffle 14.2 shown in FIG. 2 on the downstream side is preferred. The humidifier 1 can generally be equipped with two such baffles 14, so that it has one such baffle 14 in both the supply air stream 2 and the exhaust air stream 3. Accordingly, humidifier 1 can be equipped with supply air baffle 14.1 and exhaust air baffle 14.2. An embodiment is also possible in which the humidifier 1 is equipped only with the supply air baffle 14.1, i.e., only with a baffle 14, which is arranged in the supply air stream 2. An embodiment is also possible in which the air humidifier 1 is equipped only with the exhaust air baffle 14.2, i.e., only with a baffle 14 arranged in the exhaust air stream 3.

The respective baffle 14 is arranged in the housing 4 between the membrane block 10 and one of the connections 5 in such a way that the baffle 14 faces the connection 5 in question, in particular directly. As a result, a projection 22 of a cross-section 20—through which a stream can pass—of the respective connection 5 parallel to a main stream direction 21 indicated by an arrow, which is the direction of the air stream 15 in the respective connection 5, meets the baffle 14 in the direction of the membrane block 10. In FIGS. 1 and 2, this projection 22 is indicated by broken lines, in FIG. 1 for the supply air inlet 6 and in FIG. 2 for the exhaust air outlet 9.

Furthermore, the respective baffle 14 in the housing 4 is arranged so that air stream 15 can pass around it at the edge. For this purpose, the respective baffle 14 is dimensioned such that a circumferential gap 24 or annular gap 24 is formed between a circumferential edge 23 of the baffle 14 and the housing 4, through which the air stream 15 can pass and thereby pass around the edge of the baffle 14.

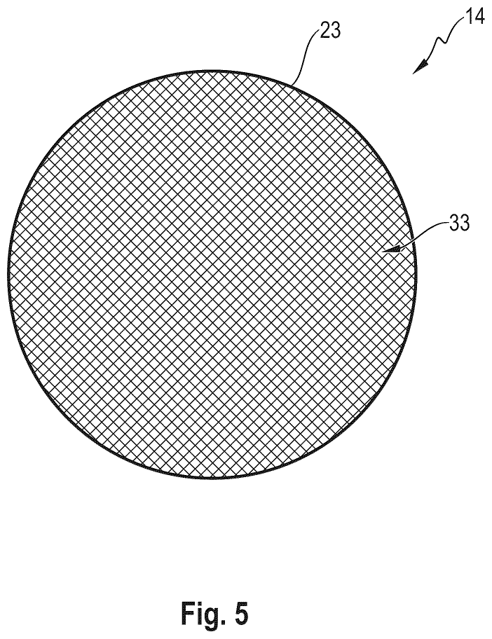

The respective baffle 14 is also configured so that air stream 15 can pass through it. It is advantageous for the baffle 14 to be configured such that it is larger in a central region 25 of the baffle, through which a stream can pass, which is marked by curved brackets in FIGS. 1 and 2, than in an edge region 26 through which a stream can pass, which is marked by curved brackets in FIGS. 1 and 2 and which surrounds the central region 25 in a ring shape. The central region 25 and the edge region 26 can also be seen in FIGS. 3 and 4.

The humidifier 1 according to FIG. 1 has guide ribs 41 arranged and/or formed on the inside of the housing 4 upstream and downstream of the membrane block 10. The guide ribs 41 serve to improve the guidance of the supply air stream 2 upstream toward the membrane block 10 and/or toward the baffle 14, as well as downstream to improve the guidance of the supply air stream 2 away from the membrane block 10.

The guide ribs 41 upstream of the membrane block 10 support the guidance of the supply air stream 2 toward the baffle 14. In particular, the guide ribs 41 support the inflow to the edge region 26 through which a stream can pass or to the edge 23 of the baffle 14, around the edge of which a stream can pass, which in turn has a positive effect on the homogenization of streaming through the membrane block 10 in the supply air path 12 through the baffle 14.

It is also conceivable that guide ribs 41 are arranged and/or formed on the inside of the housing 4 of the air humidifier 1 either only upstream of the membrane block 10 or only downstream of the membrane block 10 in the supply air stream 2.

It is also conceivable that corresponding guide ribs 41 are alternatively or additionally arranged and/or formed in the exhaust air stream 3 upstream and/or downstream of the membrane block 10 (not shown).

According to FIG. 3, the baffle 14 may have several passage openings 27, 28, 29 through which the air stream 15 can pass. The passage openings 27 formed in the central region 25 may have a smaller opening cross-section 40 through which a stream can pass than the passage openings 29 formed in the edge region 26. In the example shown in FIG. 3, three different types or sizes of passage openings 27, 28, 29 are shown purely as examples and without limitation to the general case. The first passage openings 27 are located in the central region 25 and each have a comparatively small opening cross-section 40 through which a stream can pass. The second passage openings 28 are located in a middle region 30, which is located between the central region 25 and the edge region 26. The second passage openings 28 have a middle cross-section 40 through which a stream can pass which is in any case larger than the cross-section 40 of the first passage openings 27. The third passage openings 29 are located in the edge region 26 and each have a relatively large opening cross-section 40 through which a stream can pass, which is larger than the middle opening cross-section 40 of the second passage openings 28 and thus also larger than the small opening cross-sections 40 of the first passage openings 27. In the example shown in FIG. 3, the passage openings 27, 28, 29 are circular in shape without limiting the generality. However, they can generally have any geometry.

In an alternative embodiment shown in FIG. 4, the baffle 14 may have several passage openings 31 through which the air stream 15 can pass, each extending from the central region 25 to the edge region 26. The passage openings 31 have an opening width 32 which increases from the inside to the outside, i.e., in the direction of the edge 23, so that the opening width 32 in the central region 25 is smaller than in the edge region 26. In the example shown in FIG. 4, the passage openings 31 are designed to be triangular in shape purely for illustrative purposes. The passage openings 31 converge from the outside toward the inside.

According to FIG. 5, the baffle 14 may optionally have a grid 33, which is arranged in FIG. 5 on a side of the baffle 14 facing the viewer. The grid 33 can be arranged on the upstream side or the downstream side of the respective baffle 14. The air stream 15 can pass through the grid 33 and the latter is also configured so that it generates turbulence when air passes through it in the air stream 15. In the example shown in FIG. 5, grid 33 completely covers baffle 14. In particular, the grid 33 according to FIG. 5 can be flush with the edge 23 of the baffle 14. In another embodiment, the grid 33 may protrude beyond the edge 23 of the baffle 14. In particular, the grid 33 can extend to the housing 4 and be supported by the housing 4 in a suitable manner and bridge the annular gap 24.

In another embodiment, as shown in FIGS. 3 and 4, an optional grid 34 may be arranged or formed in each of the passage openings 27, 28, 29, 31, which completely fills the opening cross-section 40 of the respective passage opening 27, 28, 29, 31. In FIG. 3, purely as an example and representative of all other passage openings 27, 28, 29, such an optional grid 34 is shown at one of the third passage openings 29. In FIG. 4, such an optional grid 34 is also shown in only one of the passage openings 31, representing all other passage openings 31.

In FIGS. 3 through 5, the baffle 14 has a circular form purely by way of example and without limitation to the general case. It is clear that the baffle 14 is suitably adapted to a cross-section of the membrane block 10, which the membrane block 10 has on a side facing the respective connection 5 and which extends perpendicular to the main stream direction 21 of the respective connection 5. In particular, the membrane block 10 can be configured in a rectangular shape so that it has a rectangular cross-section on its upstream side on the supply air side 16, on its downstream side on the supply air side 17 and/or on its upstream side on the exhaust air side 19 and on its downstream side on the exhaust air side 18. Accordingly, the respective baffle 14 may also have a rectangular shape.

In the embodiment shown in FIG. 2, baffle 14, which is arranged in the exhaust air stream 3 downstream of the membrane block 10 in the housing 4, i.e., the exhaust air baffle 14.2, is additionally configured as a droplet separator 35. Liquid water is transported in the form of droplets in exhaust air stream 3. On the downstream side on the exhaust air side 18, the exhaust air stream 3 laden with droplets emerges from the membrane block 10 and meets the baffle 14 arranged on the downstream side, where it can adhere and collect and finally flow off. The housing 4 is equipped with a water collection volume 36, which is formed, for example, in a water collection container 37 or provided in some other manner in the housing 4. The baffle 14, which acts as a droplet separator 35 here, is configured to supply the separated water or droplets to the water collection volume 36. The water collection volume 36 and/or the associated water collection container 37 can be equipped with a drain valve 38, which can be used to drain the water collected in the water collection volume 36 in a targeted manner. On the baffle 14, which acts as a droplet separator 35, several guide grooves 39 may be formed on the upstream side, some of which are shown in FIG. 4 for illustrative purposes only. These guide grooves 39 are configured to guide droplets separated at the baffle 14 to the water collection volume 36.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A humidifier for humidifying a dry supply air stream via a humid exhaust air stream, comprising:
a housing including four connections, the four connections including a supply air inlet for supplying the supply air stream, a supply air outlet for discharging the supply air stream, an exhaust air inlet for supplying the exhaust air stream, and an exhaust air outlet for discharging the exhaust air stream;
a membrane block including a plurality of membranes configured to be impermeable to air and permeable to water vapor, the plurality of membranes forming in the membrane block a supply air path through which the supply air stream is flowable and an exhaust air path through which the exhaust air stream is flowable; and
at least one baffle arranged in the housing outside of the membrane block such that the at least one baffle is capable of being impelled by an air stream formed by the supply air stream and/or the exhaust air stream; and
wherein the at least one baffle is arranged and/or configured to provide homogenization of streaming through the membrane block in the supply air path and/or in the exhaust air path.

2. The humidifier according to claim 1, wherein the at least one baffle is arranged in the housing between the membrane block and a connection of the four connections such that the at least one baffle faces the connection.

3. The humidifier according to claim 1, wherein the at least one baffle is arranged in the housing such that the air stream is passable around the at least one baffle at a plurality of edges of the at least one baffle.

4. The humidifier according to claim 1, wherein the at least one baffle is configured such that the air stream is passable through the at least one baffle.

5. The humidifier according to claim 4, wherein the at least one baffle is configured such that a first stream resistance in a central region of the at least one baffle, through which a stream is passable, is greater than a second stream resistance in an edge region of the at least one baffle, through which a stream is passable.

6. The humidifier according to claim 5, wherein:
the at least one baffle includes a plurality of passage openings through which the air stream is passable; and
a first subset of the plurality of passage openings disposed in the central region have a smaller opening cross-section through which a stream is passable than a second subset of the plurality of passage openings disposed in the edge region.

7. The humidifier according to claim 5, wherein:
the at least one baffle includes a plurality of passage openings through which the air stream is passable, the plurality of passage openings extending from the central region to the edge region; and
the plurality of passage openings each have an opening width through which a stream is passable, the opening width being smaller in the central region than in the edge region.

8. The humidifier according to claim 1, further comprising a grid for generating turbulence arranged on an upstream side and/or a downstream side of the at least one baffle.

9. The humidifier according to claim 8, wherein:
the grid completely covers the at least one baffle;
the baffle has a circumferential edge; and
the grid ends flush with the circumferential edge of the at least one baffle.

10. The humidifier according to claim 6, further comprising a plurality of grids that are each arranged in a respective passage opening of the plurality of passage openings and completely fill the opening cross-section of the respective passage opening.

11. The humidifier according to claim 1, wherein:
the at least one baffle is arranged in the supply air stream upstream and/or downstream of the membrane block in the housing; and/or
the at least one baffle is arranged in the exhaust air stream upstream and/or downstream of the membrane block in the housing.

12. The humidifier according to claim 1, wherein:
the at least one baffle is arranged in the exhaust air stream downstream of the membrane block in the housing and is configured as a droplet separator;
the housing has a water collection volume; and
the at least one baffle is configured to supply separated droplets to the water collection volume.

13. The humidifier according to claim 12, wherein the water collection volume includes a drain valve such that water collected in the water collection volume is drainable from the water collection volume periodically and/or at a certain fill level.

14. The humidifier according to claim 12, wherein the at least one baffle includes a plurality of guide grooves disposed on an upstream side of the at least one baffle, the plurality of guide grooves structured and arranged to guide separated droplets disposed on the at least one baffle to the water collection volume.

15. The humidifier according to claim 1, further comprising:
a plurality of upstream guide ribs arranged on an inside of the housing upstream of the membrane block for improved guidance of the supply air stream and/or the exhaust air stream to the membrane block and/or to the baffle; and/or
a plurality of downstream guide ribs arranged on the inside of the housing downstream of the membrane block for improved guidance of the supply air stream and/or the exhaust air stream from the membrane block and/or from the baffle.

16. The humidifier according to claim 7, further comprising a plurality of grids that are each arranged in a respective passage opening of the plurality of passage openings and completely fill an opening cross-section of the respective passage opening.

17. The humidifier according to claim 8, wherein:
the grid completely covers the at least one baffle;
the baffle has a circumferential edge; and
the grid protrudes beyond the circumferential edge of the at least one baffle.

18. The humidifier according to claim 1, wherein the at least one baffle includes:
a first baffle arranged in the supply air stream; and
a second baffle arranged in the exhaust air stream.

19. A humidifier for humidifying a dry supply air stream via a humid exhaust air stream, comprising:
a housing including four connections, the four connections including:
a supply air inlet for supplying the supply air stream;
a supply air outlet for discharging the supply air stream;
an exhaust air inlet for supplying the exhaust air stream; and
an exhaust air outlet for discharging the exhaust air stream;
a membrane block including a plurality of membranes forming, in the membrane block, a supply air path through which the supply air stream is flowable and an exhaust air path through which the exhaust air stream is flowable; and
at least one baffle arranged in the housing such that an air stream formed by the supply air stream and/or the exhaust air stream contacts the at least one baffle;
wherein the plurality of membranes are impermeable to air and permeable to water vapor;
wherein the at least one baffle is structured and arranged to provide homogenization of streaming through the membrane block in the supply air path and/or in the exhaust air path; and
wherein a first stream resistance in a central region of the at least one baffle is greater than a second stream resistance in an edge region of the at least one baffle, the edge region of the at least one baffle surrounding the central region of the at least one baffle.

20. The humidifier according to claim 19, wherein:
the at least one baffle includes a plurality of passage openings through which the air stream is passable; and
an opening width of each of the plurality of passage openings decreases in a direction toward a center of the at least one baffle.
